(19) United States
(12) Patent Application Publication
(10) Pub. No.: US 2018/0337938 A1
(43) Pub. Date: Nov. 22, 2018

(54) METHOD FOR PROTECTING A NETWORK AGAINST A CYBERATTACK

(71) Applicant: Robert Bosch GmbH, Stuttgart (DE)

(72) Inventors: Marcel Kneib, Mainhardt (DE); Christopher Huth, Leonberg (DE); Clemens Schroff, Kraichtal (DE); Hans Loehr, Stuttgart (DE); Herve Seudie, Moensheim (DE); Paulius Duplys, Markgroeningen (DE); Rene Guillaume, Boeblingen (DE); Robert Szerwinski, Stuttgart (DE); Sebastien Leger, Stuttgart (DE)

(21) Appl. No.: 15/967,157

(22) Filed: Apr. 30, 2018

(30) Foreign Application Priority Data
May 19, 2017 (DE) 102017208547.9

(51) Int. Cl. H04L 29/06; G06F 21/44; G06F 21/60; H04L 29/08; H04L 29/12; H04L 12/40

(52) U.S. Cl. CPC H04L 63/1425; H04L 63/1416; H04L 63/1441; H04L 63/0876; H04L 2012/40215; G06F 21/606; H04L 67/12; H04L 61/6027; H04L 12/40; G06F 21/44

(57) ABSTRACT

A method for protecting a network against a cyberattack, in which for a message in the network first characteristics of a first transmission of the message are determined and an origin of the message in the network is determined by a comparison of the first characteristics with at least one fingerprint of at least one subscriber or a segment of the network or a transmission route. If a manipulation of the message is detected, a point of attack of the cyberattack in the network is detected and localized in particular on the basis of the origin of the message.

### CROSS REFERENCE

The present application claims the benefit under 35 U.S.C. § 119 of German Patent Application No. DE 102017208547.9 filed on May 19, 2017, which is expressly incorporated herein by reference in its entirety.

### FIELD

A method is provided for protecting a network against a cyberattack, network subscribers equipped for this purpose and a computer program equipped for this purpose.

### BACKGROUND INFORMATION

A method is described in PCT Application No. WO2012/159940 A2 to use a fingerprint for characterizing a vehicle network in order to be able to ascertain a manipulation of the vehicle network. The fingerprint for this purpose is obtained in particular from a network configuration.

European Patent No. EP 2 433 457 B1 describes a security system for vehicles as well as methods for intrusion detection as well as measures for reaction in the event that a respective cyberattack is ascertained.

### SUMMARY

In accordance with the present invention, methods are provided, which increase the protection of a network by making it possible to detect and in particular localize a cyberattack on the network on the basis of a transmission in the network. For this purpose, characteristics of the transmission are compared with at least one fingerprint. The fingerprint goes back to previously determined characteristics of the transmission. These are preferably analog characteristics. A fingerprint prepared in this manner is preferably digitized, however. The localization is preferably performed for a network subscriber, a network segment or a transmission route of the network. A network or a subscriber of a network are equipped to perform the described methods in that they have electronic memory and computing resources to perform the steps of a corresponding method. It is also possible for a computer program to be stored on a memory medium of such a subscriber or on the distributed memory resources of a network, which computer program is designed to perform all steps of a corresponding method when it is executed in the subscriber or in the network.

The provided methods allow for an improved detection of cyberattacks and for a more targeted reaction to the attack due to a localization of the point of attack of a cyberattack on the network. If the utilized fingerprint is determined on the basis of a model (e.g., including a learning algorithm, a neural network, a stochastic model or a data-based model) from suitable characteristics of a transmission, then it is possible to design the method in a particularly reliable and robust manner.

Additional advantages of the provided methods are that no additionally transmitted data are required, as a result of which there is also no negative effect on real-time requirements of the network. An attacker outside of the network is not able to modify the physical characteristics of the transmission since these result from hardware properties of the network and its components and thus are not accessible to higher software layers.

In preferred developments, the utilized characteristics of the transmission include physical properties of the network, of transmission channels or transmission media of the network such as cables, coupling networks, filter circuits or connections, the subscriber hardware, in particular of transceivers or microcontrollers, a topology of the network or of network terminations or terminal resistors, a length of transmitted message bits, a jitter of the transmission, a current flow direction of the transmission, an inner resistance of a network subscriber during the transmission, a voltage curve during the transmission, frequency components of the transmission or a clock offset or times of a transmission.

If several of these characteristics are utilized, then it is possible for the method to detect an attack and to localize a point of attack in the network particularly reliably. A manipulation of the localization is markedly impeded. In particular, a successfully attacked transmitter unit is impeded from passing itself off as another transmitter unit.

In a particularly preferred development of the method, when a manipulation is detected, the error handling is performed in a targeted manner for a localized network subscriber, a localized network segment or for a localized transmission route of the network. For this purpose, it is possible to restrict or deactivate the function of the localized network subscriber, the localized network segment or the localized transmission route in the network, to exclude them from the network via a deactivated gateway or not to transmit or to discard messages originating from them.

By specific circuit technology or hardware selection or manipulation of components of the network, it is also possible to introduce the utilized characteristics into the network or reinforce them in the network. The reliability of the detection and localization of a point of attack may thereby be increased further.

### BRIEF DESCRIPTION OF THE DRAWINGS

The present invention is described in more detail below with reference to the figures and on the basis of exemplary embodiments.

FIG. 1 shows an exemplary network having multiple network subscribers in a schematic representation.

FIG. 2 shows a schematic sequence of an exemplary method for protecting a network against a cyberattack.

FIGS. 3 and 4 show other exemplary networks having multiple network subscribers in schematic representations.

FIGS. 5 and 6 show respectively an exemplary construction of a network subscriber including a monitoring unit in schematic representations.

### DETAILED DESCRIPTION OF EXAMPLE EMBODIMENTS

The present invention relates to a method for protecting a network against a cyberattack and for localizing a point of attack of such a cyberattack in the network.

The security of networks generally and specifically of networks in vehicles against cyberattacks is becoming more and more important. Such attacks are becoming more relevant especially for networked and automated vehicles. Researchers were able to demonstrate successful remote attacks on vehicle control units. This makes it possible for attackers to take over control functions in the vehicle in that messages are input into a vehicle network via the successfully attacked control units.

On the one hand, it is important to detect an attack on a network and to identify the harmful messages input in the process. On the other hand, it is also important to identify the origin of the attack, that is, the attacked network subscriber or at least the attacked network segment, inter alia in order to be able to introduce specific countermeasures. If a message is identified as malicious, then the task is now to detect on the basis of digital or analog characteristics of the transmission of the message, from which network subscriber or from which network segment the message originates.

For this purpose, physical properties of the network, for example of network subscribers (or their transceiver or microcontroller), static influences of the network topology (in particular of cables and connecting elements) or of terminal resistors are to be used to determine the origin of a message in the network. If characteristics are suitably determined from these physical properties, on the basis of which the origin of a transmission may be determined, then it is hardly possible for a remote attacker to influence these, quite in contrast to message contents including sender addresses etc. In another development, such characteristics may also be specifically introduced into the system, for example, by the selection, the composition or the deliberate manipulation of hardware components of the network. Such specific characteristics may be selected in such a way that they are more distinguishable and that it is possible to assign the respective physical fingerprints to the corresponding network subscribers or network segments in a simpler, more definite or robust fashion.

For this purpose, the fingerprints may
characterize or authenticate a network or a subnetwork as a whole,
characterize or authenticate a specific transmission path or transmission channel in the network or
characterize or authenticate individual network subscribers (e.g. control units in a vehicle network or gateways of a network).

It is also possible to use fingerprints of these three distinct developments in combination in a system.

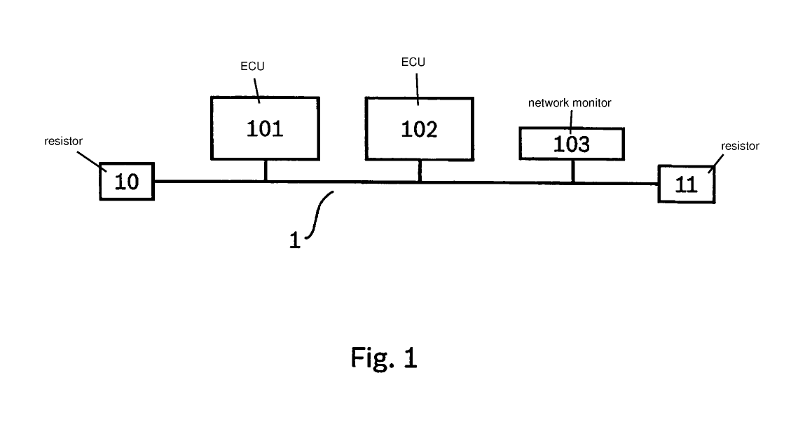

FIG. 1 shows, as an exemplary network, a bus 1 having terminal resistors 10 and 11. An ECU 101, an ECU 102 and a network monitor or network monitoring unit 103 are connected to bus 1 as network subscribers. Network monitor 103 preferably has transmitting and receiving means to be able to receive messages of bus 1 and to transmit messages to bus 1. In addition, it preferably includes evaluating means to be able to determine the physical characteristics of a transmission of a message on the bus as well as a processing unit in order to be able to ascertain with the aid of a model an origin of the message from the determined characteristics and predetermined fingerprints.

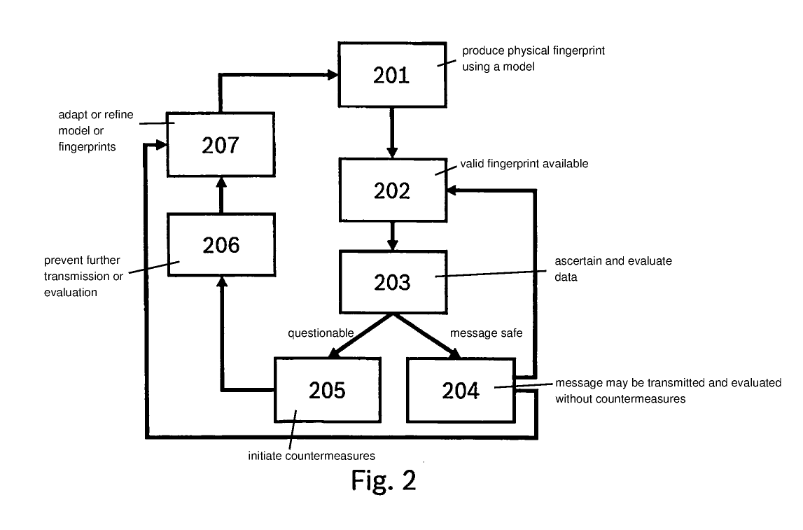

FIG. 2 shows an exemplary sequence of a method for protecting a network against cyberattacks. Initially, a physical fingerprint is produced in a first step 201, in particular with the aid of a model. This may be done via measurement of the required physical characteristics using external measuring devices (for example an oscilloscope), in particular in secure surroundings (for example in the factory). Alternatively, it is also possible to use internal measuring devices to determine physical characteristics (e.g. using means of a network subscriber, e.g., of a control unit on a vehicle network, or in measuring devices of a network node specifically for network monitoring). Alternatively, it is also possible to receive and store the model and/or fingerprints from outside, e.g. from an Internet server.

The model may be taught and determine the fingerprints in various ways. For example, it is possible to transmit a specific test pattern in the network, which may be in particular uncorrelated to other messages expected on the bus. Alternatively, the fingerprints may also be determined on the basis of regular messages transmitted during the normal operation of the network or may be determined from portions of these messages. It is also possible for specific network subscribers to be prompted by message to respond in a specific way, and for fingerprints to be determined on the basis of the transmission of the specific responses. Optimally, the fingerprints are taught with the aid of the model on the basis of the measured physical characteristics of repeated and different transmissions so as to allow later, on the basis of the fingerprints, for a robust authentication.

Preferably, a step response or a pulse response of a network to a transmission is utilized for preparing the fingerprints. This makes it possible in particular to describe also the reflections occurring in the system, which result from the structure of the network, its transmission means, its resistances and its connected hardware elements. A test pulse may be produced for this purpose by an ordinary subscriber or by a special test subscriber. For this purpose, the test pulse may be made up of one or any number of level changes, in which the time periods between the level changes are definite or indefinite. It is also conceivable that the network for this purpose is put into a special learning mode, during which no normal data transmission occurs, for example. For producing the test pulse, the transmitter of the test pulse may have special modules of hardware and/or software.

For a CAN network, a fingerprint may be determined for example in that only one of the CAN high and CAN low lines are measured (measurement against ground). This would require a relatively low measuring effort. Alternatively, the fingerprint may also be produced from the measurement of both, or the differential signal may also be used. This makes it possible to determine fingerprints of higher quality.

A valid model or valid fingerprints are available in step 202 so that in step 203 it is possible to check communication in the network by comparison with the model or the fingerprints with respect to their origin. In this step it is possible to determine concretely individual messages and their contents (e.g., individual message frames on a CAN bus or individual bits within such a frame), the transmission times, patterns of higher order in the message traffic of one or multiple transmission subscriber(s) (in particular transceiver(s)) and the physical characteristics of the transmission. With this information, it is possible to identify harmful or unexpected messages and recognize them as (alleged) messages due to a cyberattack. By comparing the determined physical characteristics with the taught model or the ascertained fingerprints, it is additionally possible, particularly for such messages, to determine the origin of the message and thus to identify a cyberattack or to determine a point of attack of the cyberattack. The latter in turn allows for a specific reaction to the attack at the point of attack.

The ascertainment and evaluation of the data in step 203 may be performed by individual network subscribers, e.g. by individual control units of a vehicle network. Alternatively, it is also possible to use for this purpose separately provided monitoring units as network subscribers. Particular properties, e.g. transmission times, but also additional physical characteristics, may be ascertained without special hardware. For other properties, especially in the desired degree of detail, additional hardware in the units is useful. It is preferably useful to transmit the ascertainment and evaluation to particular network subscribers and to equip these accordingly. These may also have additional securing mechanisms, e.g., a TPM (trusted platform module). The evaluation of the data may also be performed cooperatively by several network subscribers.

The ascertainment and evaluation of the data may occur periodically or dynamically, in particular in order to reduce the required memory space when a need is determined. Storing the data makes it possible to perform an analysis of the origin also for past messages if there is a suspicion that a cyberattack has been perpetrated on the network. Real-time ascertainment and real-time calculation are preferable in order to react to attacks as quickly as possible.

The ascertained data may be stored in each control unit individually, in one or multiple network monitoring units or also outside of the network. In an advantageous development, the data are stored in different places in order to impede an attack on the data. In the case of a vehicle network, it is also possible to store the data outside of the vehicle, e.g. on a server. This has the advantage that an evaluation and reaction may occur even for other vehicles or from a superordinate station and that in the event of a cyberattack on the vehicle, the data cannot be (readily) the object of the attack.

If a message is categorized as safe in step 203, the method branches to step 204 and the message may be transmitted and evaluated in the network without countermeasures. From step 204 it is possible to branch to step 202 and for data to be ascertained and analyzed for additional message transmissions. Following a branching to step 207, additionally or alternatively, it is possible to use the ascertained data to adapt or refine the model or the fingerprints. This may also contribute towards detecting potential attacks, in which the individual messages are not harmful, while they may indeed be harmful in their totality. This may be expedient since physical characteristics may also change over time, e.g. due to aging effects. From step 207, the method branches back to step 201.

If a message is evaluated as questionable, that is, is evaluated as part of a cyberattack, the method branches from step 203 to step 205. There, suitable countermeasures or reactions are initiated. In a particularly preferred development, the countermeasures or reactions are specifically adapted on the basis of the detected origin of the message.

As a reaction, in step 206, it is possible to prevent further transmission (in particular in a real-time reaction) or at least further evaluation of a message, e.g. in that dominant signals are transmitted on a message channel (which render the message illegible or at least faulty, e.g. by overwriting a test sequence) or by transmitting an error frame directly following the message. It is also possible to design these reactions as a function of where the message originated.

As a further countermeasure, it is possible in step 206, alternatively or additionally, to remove (in particular deactivate) (presumably) corrupted network subscribers from the network, in particular the network subscriber who was identified as transmitter of the message, or network subscribers from the network segment that was identified as the origin of the message. Likewise, it is possible to block transmission routes, via which the message was transmitted. Furthermore, it is also possible to block messages by gateways between specific networks or network segments in order to prevent an attack from crossing over to neighboring or additional networks or network segments.

It is possible, for example, to divide the network in a vehicle into logically and/or physically separated segments. For example, the network segment, to which a head unit of the vehicle is connected, may be separated by a gateway from another network segment, the additional network segment being used by safety-critical control units (e.g., for engine control, for ABS or EPS functions). If such a gateway, which separates two network segments, is identified via characteristics of the transmission or corresponding fingerprints as the source of a message in one of the segments, which an attacker is not able to manipulate via software, then it is possible to discard messages specifically from this gateway (and thus from the other network segment) or the gateway itself may be deactivated straightaway. This makes it possible to protect a safety-critical network segment from the effects of an attack on another network segment.

Another countermeasure in step 206 could be switching off the supposed receiver of the message. Apart from a complete deactivation, it would also be conceivable to switch to an operating mode having reduced functionality, e.g. an emergency operating mode.

Finally, alternatively or additionally, it is also possible to transmit warning signals or error reports within the network or out of the network, which contain the detected attack and preferably the ascertained origin.

In the following step 207, it is in turn possible to adapt or refine the model or the fingerprints on the basis of the ascertained and evaluated data.

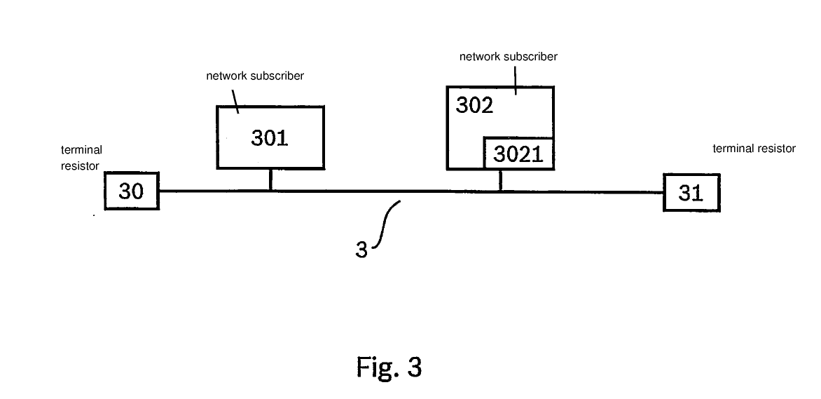

As described, the mentioned methods may be performed by different constellations on network subscribers. While FIG. 1 shows a separate bus monitoring unit 103, which performs the described methods alone or together with network subscribers 101 and 102, FIG. 3 shows an alternative configuration. FIG. 3 shows a bus 3 having terminal resistors 30 and 31 as well as two network subscribers 301 and 302. In contrast to network subscriber 301, network subscriber 302 has an additional hardware component 3021 for supporting or carrying out the provided methods. For this purpose, the hardware component has additional measuring devices for measuring physical characteristics of a transmission in the network and/or an additional evaluation unit for analyzing the ascertained data. The measuring device as well as the evaluation unit may be partially or even completely made up of a processing unit.

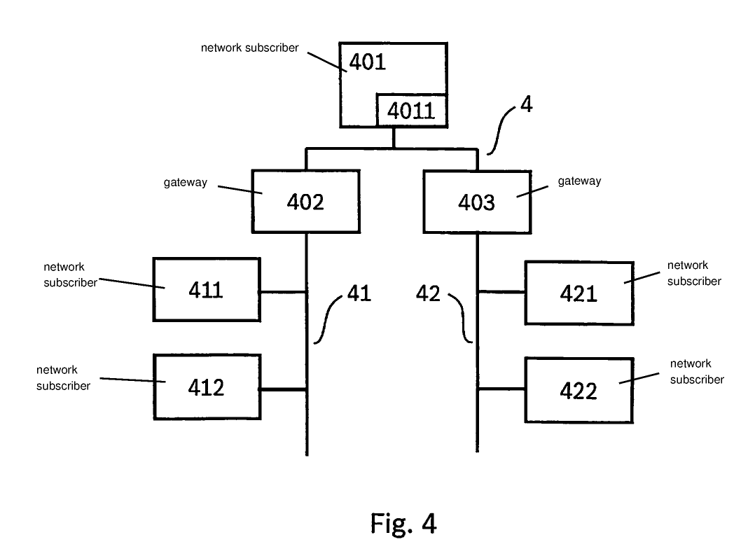

In FIG. 4, a comparable hardware component 4011 is integrated into network subscriber 401. Network subscriber 401, however, is in this case a domain control unit, which is connected to a network backbone 4. Gateways 402 and 403 connect the network backbone with network segments or networks 41 and 42. Network subscribers 411 and 412, and 421 and 422, are connected to networks 41 and 42, respectively. The domain control unit is now able to determine and localize an attack alone or in combination with the other network subscribers and is able to initiate appropriate countermeasures. This chiefly includes blocking messages from a network or network segment via one of the gateways.

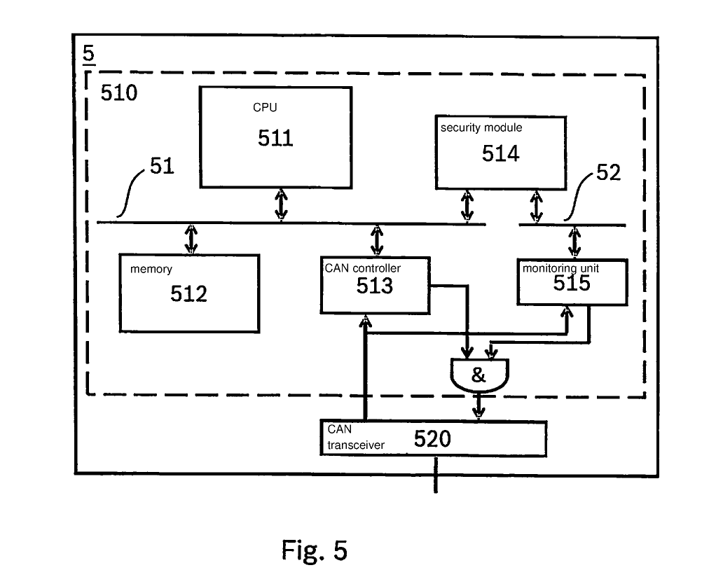

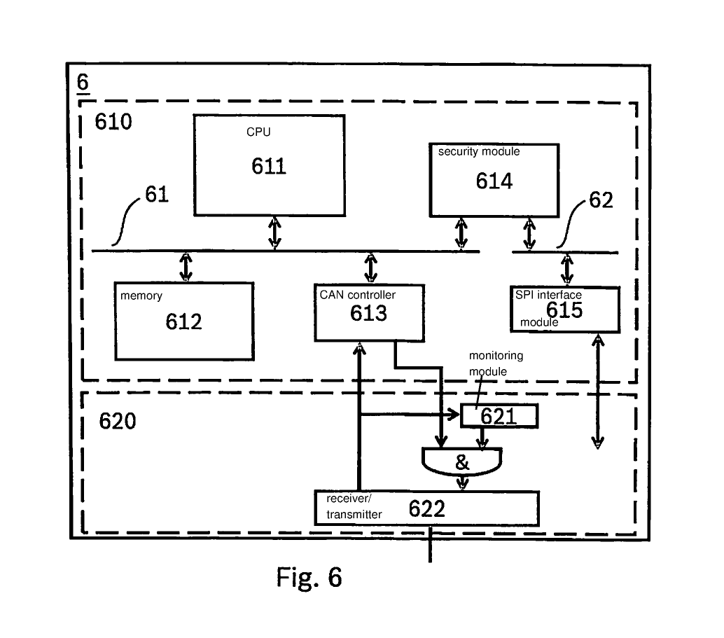

FIGS. 5 and 6 show preferred developments of how a hardware component for performing or supporting the provided methods may be integrated into a network subscriber.

FIG. 5 shows as network subscriber in part a control unit 5 comprising a microcontroller 510 as well as a CAN transceiver 520. Microcontroller 510 comprises a CPU 511, a memory 512, a CAN controller 513 as well as a security module 514 (e.g. a hardware security module, i.e., a module having a secured memory and a separate secured processing unit), which are respectively connected to an internal communication line 51 (host interface). Security module 514 is additionally connected to an additional secure communication connection 52 (secure interface). In this development, microcontroller 510 comprises as a hardware component for implementing or supporting the provided methods a monitoring unit 515, which is likewise connected to secure communication connection 52. A receiving line (CAN Rx) from the side of CAN receiver 520 leads from the latter respectively to CAN controller 513 and monitoring unit 515. A transmission line (CAN Tx) in the direction of CAN transceiver 520 leads respectively from CAN controller 513 and monitoring unit 515 via a common AND block (&) to CAN transceiver 520. CAN transceiver 520 is connected to a CAN bus (CAN H, CAN L).

In an alternative development, FIG. 6 shows as a network subscriber, likewise in excerpted form, a control unit 6 comprising a microcontroller 610 and a CAN transceiver 620. Microcontroller 610 comprises a CPU 611, a memory 612, a CAN controller 613 and a security module 614 (e.g., a hardware security module, i.e. a module having a secured memory and separate secured processing unit), which are respectively connected to an internal communication line 61 (host interface). Security module 614 is additionally connected to an additional secure communication connection 62 (secure interface). An SPI interface module 615 is likewise connected to the secure communication connection 62. In this development, CAN transceiver 620 comprises as hardware component for implementing or supporting the provided methods a monitoring unit 621, which is connected via the SPI interface unit 615 of the microcontroller to secure communication connection 62 of the microcontroller. A receiving line (CAN Rx) from the side of the receiving and transmitting means 622 of CAN transceiver 620 leads from the latter respectively to CAN controller 613 and to monitoring module 621. A transmitting line (CAN Tx) in the direction of receiving and transmitting means 622 of CAN transceiver 620 leads respectively from CAN controller 613 and monitoring module 621 via a common AND block (&) to receiving and transmitting means 622, which are connected to a CAN bus (CAN H, CAN L).

Various characteristics may be used for manipulation detection.

It is possible, for example, to ascertain and evaluate the length of the transmitted bits, or the length of the levels on the network line. In favorable implementations, the actual measuring point for detecting the level is defined, e.g., at approx. ¾ of the nominal bit length. This allows for bits to fluctuate in their length and nevertheless to be reliably detected. These fluctuations (jitter) may be particular to each module and may therefore be evaluated as characteristics. It is also possible specifically to introduce such fluctuations into the network by selection or manipulation of the hardware of the network or of a network subscriber in order to make the origin of a message more readily identifiable.

If, for example, the control units on a critical bus have a relatively long “1,” but a gateway on the same critical bus has a relatively short “1,” then it is possible to differentiate on this basis whether a message came to the critical bus from one of the control units or via the gateway. As a reaction, it would be possible for example in the latter case to deactivate the gateway, while maintaining the communication of the control units on the bus.

A different bit length may result for example from hardware properties of a transceiver, from cable properties or from both. For a transceiver, for example, an asymmetry in the installed capacitors or in the capacitances of the electric lines may be responsible for the asymmetry of the bit length.

Instead of considering only the bit length as such, it would also be possible to use the ratio between recessive and dominant bit components as characteristics.

The jitter properties of transmissions are suitable as further characteristics for a fingerprint or the preparation of a model. Jitter may be produced for example by reflections as a result of different cable lengths in interaction with faulty termination within a network topology.

The flow direction of a charge via a communication connection of the network may also be used as a characteristic. When a signal is transmitted, this also affects a flow of electrons or charge flow.

If the direction of this flow is detected in connection with its level, it is possible to determine from which direction a signal was transmitted. The flow is preferably detected inductively, for example with the help of a measuring coil. The use of measuring resistors (shunts) would also be possible.

For this purpose, additional measuring points are preferably provided on a communication connection of the network. The charge flow depends on what type of signal (e.g., high or low on a CAN bus) is transmitted and who transmits the signal (that is, who is source and who is acceptor).

The inner resistance of the source can also play a role for distinguishing different signal sources in a transmission. It is possible, for example, specifically to vary the inner resistances of network subscribers or their components. The inner resistance influences e.g. voltage curves and charge flows.

The voltage curve over time is proposed as another characteristic of a transmission. The reason for variations in the voltage curve of a transmission between different network subscribers or network areas may be for example the respective transceivers or cable connections (contact resistances, impedances).

In another preferred development, the frequency components of the signal may be used as characteristics. Every network subscriber or every network area may introduce or dampen different frequencies in the transmission in the network, e.g., via different properties of the respective transceivers or via cable properties. It is possible to measure these frequencies or determine the different frequency components. For this purpose, it is possible to determine the frequencies in the frequency range rather than in the time range. The different frequency components also result from signal superpositions and signal reflections in the network. To increase the ability to authenticate network subscribers, it is also possible specifically to introduce different frequency characteristics into the network.

A clock offset between subscribers of the network may also be among suitable transmission characteristics.

In a preferred development, at least two different characteristics are used, which increases the reliability of assigning the manipulation and markedly reduces the manipulability.

In the event of a change in the hardware of a network or its components, it may be necessary to adapt the fingerprints or learn them anew. This may be the case, for example, during a workshop visit (exchange, modification, supplementation or removal of a component) or also when the system ages. In this instance, preferably the system-wide fingerprints are adapted or learned anew, since such changes often also affect the fingerprints of other components or segments. Such an adaptation or learning process may be started automatically, e.g., even when the system automatically detected a change of characteristics. Alternatively, such an adaptation process may also be initiated by an authorized station.

In a preferred development, the characteristics are ascertained from individual received bits, in particular for every received bit. For this development, it is possible to store in particular the measured analog values of a transmission, not only the extracted digital values. The bits of a message may be divided into four groups, depending on the digital value at the beginning and at the end of the respective bit: 00, 01, 10, 11. For a sequence “01101” this would be X0, 01, 11, 10, 01. Without knowledge of the measuring result prior to the first bit, it is not possible for the example to determine its membership in one of the groups. If the measured value at the beginning is a high level (1), the bit is assigned to group 10, otherwise to group 00. In the real system, this problem normally does not exist since a measured value is available at the beginning of a bit sequence. For a CAN message with 8 bytes of useful data, without extended CAN ID and without stuff bits, this could be approx. 100 measured bits, for example, which are distributed into the corresponding groups.

Following this distribution, the respectively contained bits are statistically evaluated separately for each group. As statistical variables, it is possible to ascertain e.g. average values, standard deviations, average deviations, symmetry coefficients, kurtosis, quadratic average value, maximum and minimum of the measured variables, e.g., of the voltage values. It is also possible to determine multiple or all of these variables.

It is possible to scale and normalize the results. On the basis of these evaluations and results, it is then possible to calculate for each group probabilities as to which subscriber, network segment or which transmission route the characteristics may be assigned. For this purpose, classes may be formed for the subscribers, segments and routes. Using known machine learning algorithms (e.g. logistic regression, support vector machine, neural network), it is possible to determine an assignment of the results for each group to one of the classes.

For resource-limited network subscribers, it is possible to reduce the evaluation by machine learning accordingly depending on the case, e.g., to one vector multiplication per group. If a message ID exists, for example, which can already be assigned to a specific subscriber, then it is possible to check this presumed origin in a first step by determining the probability that the characteristics may indeed be assigned to the corresponding class. Only if this is not the case is it possible to determine also the probabilities for the remaining classes in order to find out from which other known subscriber, other network segment or other transmission route the message was transmitted or whether an unknown origin must be assumed.

The probabilities of the individual groups may additionally be weighted, for example on the basis of the varying accuracy or predictive power of the different groups. It is then possible to ascertain a total probability from the individual probabilities for the assignment of a bit sequence or message to a subscriber, a network segment or a transmission route. The highest probability for a class determines the corresponding assignment. From the magnitude of this probability it is possible to derive an uncertainty of the assignment. If all probabilities are below a predefined threshold, no assignment is made, and an unknown source may be assumed as origin of the message. This information may be used in turn in order to determine a cyberattack.

1. A method for protecting a network against a cyberattack, comprising:
determining, for a message in the network, first characteristics of a first transmission of the message;
determining an origin of the message in the network by comparing the first characteristics to at least one fingerprint of one of: (i) at least one subscriber of the network, (ii) a segment of the network, or (iii) a transmission route; and
localizing, as a function of the determined origin, one of: (i) a cyberattack on the network, or (ii) a point of attack of the cyberattack.

2. The method as recited in claim 1, wherein the at least one fingerprint is ascertained by a model from two characteristics of one of: (i) at least one second transmission by the network subscriber, ii) a second transmission from the network segment, or (ii) a second transmission via the transmission route.

3. The method as recited in claim 2, wherein the model comprises one of a learning algorithm, a neural network, a stochastic model, a data-based model, or an automaton-based model.

4. The method as recited in claim 2, wherein the second characteristics are determined at least one of using external measuring equipment, and in a secure environment.

5. The method as recited in claim 2, wherein the second characteristics are determined one of: (i) using internal measuring equipment, (ii) in specific system states of the network, or (iii) in specific system states of a system comprising the network.

6. The method as recited in claim 2, wherein a predetermined test pattern is transmitted in the second transmission.

7. The method as recited in claim 1, wherein the at least one fingerprint is read in from an external source, the at least one fingerprint being at least one of: (i) received from the Internet, or (ii) transmitted into the network in a factory environment.

8. The method as recited in claim 1, wherein the manipulation is detected as a function of one of: (i) a comparison between a characteristic with at least one expected characteristic, the characteristic being a content of the first message, and the at least one expected characteristic being an expected content, or (ii) a comparison of a transmission time of the first message with an expected transmission time.

9. The method as recited in claim 1, wherein a manipulation is detected as a function of an origin of the first message.

10. The method as recited in claim 1, wherein the network is a CAN bus system.

11. The method as recited in claim 1, wherein the network is a vehicle-internal network and a vehicle-internal point of attack of a cyberattack on the network is localized from outside the vehicle.

12. The method as recited in claim 1, wherein at least one of the determination of the first characteristics, and the comparison with the at least one fingerprint, is performed by at least one vehicle control unit which is connected to the network.

13. The method as recited in claim 1, wherein the vehicle control unit has a monitoring unit that is integrated into one of a microcontroller or a transceiver of the vehicle control unit.

14. The method as recited in claim 1, wherein the vehicle control unit is one of a central control unit of the vehicle or a domain control unit of the vehicle.

15. The method as recited in claim 1, wherein at least one of the determination of the first characteristics and the comparison with the at least one fingerprint, is performed by one of: (i) at least one network subscriber specifically provided for monitoring, or (ii) a connected processing unit outside of the vehicle.

16. The method as recited in claim 1, wherein the first characteristics are determined on the basis of a step response or a pulse response of the network during the transmission.

17. The method as recited in claim 1, wherein the first characteristics comprise one of: (i) physical properties of the network, (ii) physical properties of transmission channels, (iii) physical properties of transmission media of the network, (iv) physical properties of a hardware of the network subscribers, (v) physical properties of transceivers or microcontrollers, (vi) physical properties of a topology of the network, or (vii) physical properties of network terminations or terminal resistors.

18. The method as recited in claim 1, wherein the first characteristics comprise one of: (i) a length of transmitted message bits, (ii) a jitter of the transmission, (iii) a current flow direction of the transmission, (iv) an inner resistance of a network subscriber during the transmission, (v) a voltage curve during the transmission, (vi) frequency components of the transmission, or (vii) a clock offset during the transmission.

19. The method as recited in claim 1, wherein the first characteristics comprise times of a transmission.

20. The method as recited in claim 1, wherein the first characteristics are introduced into the network or are reinforced in the network via hardware selection or hardware manipulation.

21. The method as recited in claim 1, wherein multiple different second characteristics are used for the at least one fingerprint.

22. The method as recited in claim 16, wherein on the basis of a variability of ascertained characteristics the model uses determined reliable characteristics for the at least one fingerprint.

23. The method as recited in claim 1, wherein data regarding the first characteristics or regarding the at least one fingerprint are distributed in the vehicle or are stored outside the vehicle on a server.

24. The method as recited in claim 1, wherein, in the event of a detected manipulation of the message, an error handling is performed, the error handling including one of: (i) a termination of the transmission of the message, (ii) an identification of the message as invalid, (iii) an exclusion of the localized point of attack from the network, (iv) a deactivation of a gateway of the network in order to cut off a localized point of attack of the network from other parts of the network, or (v) a transmission of a warning message about the detected manipulation.

25. The method as recited in claim 24, wherein the error handling is performed specifically for one of a localized network subscriber, a localized network segment, or a localized transmission route of the network.

26. The method as recited in claim 1, wherein the at least one fingerprint is adapted, newly prepared or newly received and stored if a message with an authorization that is sufficient for this purpose is received.

27. The method as recited in claim 1, wherein the fingerprint is one of: (i) adapted at specified time intervals, (ii) adapted in predetermined system states, (iii) newly prepared, or (iv) newly received and stored.

28. The method as recited in claim 1, wherein the first characteristics are determined for individual bits of the message.

29. The method as recited in claim 28, wherein the individual bits of the message are classified into one of four groups as a function of a digital value at a beginning and at an end of the respective individual bit and the comparison with the at least one fingerprint is performed separately for each group.

30. A device, designed to protect a network against a cyberattack as a subscriber, the device designed to:
determine, for a message in the network, first characteristics of a first transmission of the message;
determine an origin of the message in the network by comparing the first characteristics to at least one fingerprint of one of: (i) at least one subscriber of the network, (ii) a segment of the network, or (iii) a transmission route; and
localize, as a function of the determined origin, one of: (i) a cyberattack on the network, or (ii) a point of attack of the cyberattack.

31. A non-transitory machine-readable storage medium on which is stored a computer program for protecting a network against a cyberattack, the computer program, when executed by a computer, causing the computer to perform:
determining, for a message in the network, first characteristics of a first transmission of the message;
determining an origin of the message in the network by comparing the first characteristics to at least one fingerprint of one of: (i) at least one subscriber of the network, (ii) a segment of the network, or (iii) a transmission route; and
localizing, as a function of the determined origin, one of: (i) a cyberattack on the network, or (ii) a point of attack of the cyberattack.
